(19) United States
(12) Patent Application Publication
(10) Pub. No.: US 2006/0186020 A1
(43) Pub. Date: Aug. 24, 2006

(54) Vegetable oil hydroconversion process

(75) Inventor: Jefferson Roberto Gomes, Rio de Janeiro RJ (BR)

Correspondence Address: NIXON & VANDERHYE, PC, 901 NORTH GLEBE ROAD, 11TH FLOOR, ARLINGTON, VA, 22203, US

(73) Assignee: Petroleo Brasileiro S.A. - PETROBRAS, Rio de Janeiro, JR (BR)

(21) Appl. No.: 11/290,486

(22) Filed: Dec. 1, 2005

(30) Foreign Application Priority Data
Feb. 18, 2005 (BR) PI 0500591-4

(51) Int. Cl. B01J 29/70

(52) U.S. Cl. 208/46

(57) ABSTRACT

A vegetable oil hydroconversion process is described for hydroconverting a mixture between 1 to 75% in mass of oil or natural fat (1) and the rest mineral oil (2), hydroconverted in a reactor (205) under conditions of pressure, temperature, hydrogen (flow 119) and sulfide catalyst of Groups VIII and VIB, obtaining, after sour water separation (flow 111) and rectification (flow 112), a specified diesel product (4). The product (4) has an ITQ/DCN (cetane number) higher than a product obtained from a pure mineral based oil would have, lower density than from a base oil and a plugging point depending on the mineral oil flow, as well as greater oxidation stability than the base oil.

### FIELD OF INVENTION

This invention belongs to the field of hydroconversion processes, more specifically, to the hydroconversion processes to obtain diesel oil from vegetable oils combined with oil.

### BASIS FOR THE INVENTION

Throughout Brazil, agriculture is an important motivating factor in promoting socioeconomic development, as well as contributing to improving environmental conditions world wide, which is being greatly affected by the economic activities of modern civilization, principally by the use of non-renewable fossil fuels in detriment to fuels derived from vegetable matter. In Brazil for some decades, ethanol, produced on a large scale, has been successfully used as a substitute for gasoline, however it wasn't possible, up to now, to implement a similar program for diesel.

Therefore, there is a great effort to make the use of what is known as “bio-diesel”, trans fatty acids with alcohol (methanol or ethanol) viable. However the production of this fuel requires the development of simple, low cost technology in order for it to be used by small agricultural producers.

The main source of these fatty acids is vegetable oils, also called fatty acid tryglicerides. They are extracted directly from vegetable seeds by a pressing process and/or extraction with organic solvent. In addition to applications in the food industry, they are mainly used in the production of soaps, paints, lubricants and plastics.

The Brazilian fuel market is greatly dependent on the supply of diesel, due to the truck and bus fleets, the main means of transport for cargo and people. Therefore, the search for alternative sources has driven many areas of research, and renewable sources have been of particular interest, as they contribute towards improving the environment and may be an extra source of resources in some regions of the country.

Some work was carried out using the oils directly in diesel engines. The idea of using pure vegetable oils, or a mixture, directly in diesel engines has been around for a long time, Rudolph Diesel himself used peanut oil in one of his engines at the 1900 Paris Exposition. However long term engine testing showed that the conventional engine is not suitable for using this fuel, both in a pure form or mixed with mineral oil, as the engines used in the tests showed carbon deposit formation, ashes, fuel chamber wear and the formation of gum in the fuel lines, as cited by Recep Altin, Selim Cetinkaya, Hüseyin Serdar Yücesu—The potential of using vegetable oil as fuel for diesel engines. Energy Conversion and Management, 42, pp 529-538, 2001.

Another important market that is also seeking to substitute diesel with a renewable source is Canada, as can be seen in the article by Mark Stumborg, Alwong, Ed Hogan—Hydroprocessed vegetable oils for diesel fuel improvement, Bioresource Technology, 56, pp. 13-18, 1996.

To convert vegetable oils directly into extra quality diesel, a hydrorefining technology was developed, based on known technology, using existing commercial catalysts. The vegetable oils used were: rape seed oil, soya oil and residual oil from cellulose production using pine trees (or any resinous plant). The oils used are low quality, i.e. they have not having been through any type of treatment, except filtering. The study resulted in the development of a new hydrotreatment process for pure vegetable oils, for production of a hydrocarbon flow with a high cetane number, as per G. N. da Rocha Filho, D. Brodzki and G. Djéga-Mariadassou—Formation of alkylcycloalkanes and alkylbenzenes during the catalytic hydrocracking of vegetable oils, Fuel, 72, pp. 543-549, 1993. Hydrocracking reactions are used for reducing the number of carbon atoms in the chain, hydrotreatment for removing oxygenated compounds and unsaturation hydrogenation for removing double bonds, for which were used NiMo and CoMo commercial gama alumina supported sulfided catalysts.

The diesel obtained amounts to 80% of the load processed, with good results in relation to the catalyst's useful life, however with a forecast of catalyst regeneration over the period. The product obtained has a cetane number varying between 55 and 90, with the production of subproducts: C₁ to C₅ gas, CO₂ and water. The liquid product is miscible in all proportions in the mineral diesel flow and, therefore, may be added to the refinery's diesel pool, improving the cetane number, but prejudicing the low temperature specifications of the final product.

Generally, the product contributes to improving emissions from diesel engines, this improvement being inversely proportional to the quality of the diesel fuel base, i.e. the worse the emissions caused by the diesel are, the better is the return by the addition of the generated product, mainly in the reduction of NOx and CO emissions.

The hydrorefining process (HDR), also known as hydroprocessing, consists of mixing oil fractions with hydrogen in the presence of a catalyst, which under determined operational conditions produces specified diesel. This process is gaining importance throughout the world and principally in Brazil, as despite being a catalytic process, under severe operational conditions (high temperatures and pressures) and which consumes hydrogen, a high production cost consumable, the advantages obtained with this refining technology outweigh the costs, allowing better use of heavy loads, improved product quality and environmental protection by removing pollutants such as sulfur and nitrogen. Therefore, resistance to the HDR process because of its high investment and operational costs, are outweighed by the benefits obtained.

Hydrotreatment (HDT) units, when used in more complex refining schemes, are intended to improve load quality, by eliminating the contaminants of subsequent processes. The product from the unit has essentially the same load distillation range, although there is secondary production of lighter products by hydrocracking. Typical loads of these units vary from the naphtha range up to heavy vacuum gasoil (GOP).

Some patent documents cover this area.

The hydrogenation of vegetable oils combined with mineral oil is mentioned in U.S. Pat. No. 2,163,563, which processes vegetable oils mixed with a mineral oil flow in the presence of hydrogen at high pressure (50 to 500 atmospheres) and uses a reduced Ni alumina supported catalyst. The converted vegetable oil is separated by distillation and the mineral oil recycled. However this patent doesn't deal with the hydrotreatment of a combined oil and vegetable oil load by a HDT process.

U.S. Pat. No. 4,300,009 describes the catalytic conversion of anabolites (substances formed in the anabolic process) such as resins, vegetable oils and fats in liquid hydrocarbons, in the presence of zeolites with an effective pore size greater than 5 Angstrom. The generated products have a boiling point in the gasoline range.

U.S. Pat. No. 5,233,109 describes a synthetic crude oil produced by the catalytic cracking of a biomass material, such as vegetable or animal oil in the presence of a catalyst which is of alumina, with or without silica and/or a zeolitic component and/or rare earths and/or sodium oxide. The reaction takes place in the presence of a carrier gas that can be air, nitrogen, argon, hydrogen and a hydrocarbon obtained from oil refining.

U.S. Pat. No. 5,705,722 describes a process to produce additives for diesel fuels with a high cetane number and serving as fuel ignition improvers. In the process, biomass containing a high proportion of unsaturated fatty acids, wood oils, animal fats and other mixtures is submitted to hydroprocessing, placing the load in contact with hydrogen gas in the presence of a hydroprocessing catalyst under hydroprocessing conditions, to obtain a product mixture. This mixture is then separated and fractioned to obtain a hydrocarbon product with a boiling point in the diesel range, and this product is a high cetane number additive. There is no mention in this document of the addition of oil hydrocarbons to the biomass load being hydroprocessed.

U.S. Pat. No. 4,992,605 uses a hydrorefining process with a sulfided catalyst (NiMo and CoMo) in the presence of hydrogen (4 to 15 Mpa pressure) and temperature varying between 350° C. and 450° C. and processes pure vegetable oils such as rape seed, sunflower, soya, palm and wood oil, which is a residue from the wood pulp industry. The final objective is to obtain a flow with a high cetane number to be added to the refinery's diesel pool, however the low temperature specifications are prejudiced. This patent doesn't cover the mixing of a hydrocarbon with the vegetable oil in hydrorefining.

U.S. Pat. No. 5,972,057 describes the transesterification of vegetable oils, principally oils used for frying, with methanol and ethanol, with the objective of producing a fuel similar to mineral diesel, however the process involves the consumption of an expensive reagent (alcohol) and the subproducts (glycerine, etc.) have to be separated in order not to damage the engine.

Therefore, despite the technological developments there is still the technical need of a process for the hydroconversion of vegetable oils in order to obtain diesel, in which a vegetable oil flow in a proportion between 1 and 75% in mass, combined at between 99% and 25% in mass with a hydrocarbon flow, is submitted to hydrotreatment under hydrotreatment conditions, the product flow with a boiling point in the diesel range has an improved cetane index and density less than that obtained by processing the usual hydrocarbon flows themselves, the same hydroconversion process being described and claimed in this request.

### INVENTION SUMMARY

In a broad manner, the invention process for vegetable oil hydroconversion includes hydrotreating a flow of oils and/or natural fats in a proportion between 1 and 75% in mass combined at between 99% and 25% in mass to a hydrocarbon flow, hydrotreated in a hydrotreatment reactor, under hydrotreatment conditions, which involve an operating pressure of 4 MPa to 10 Mpa, a catalytic bed average temperature between 320° C. and 400° C., spatial speed of 0.5 h⁻¹ to 2 h⁻¹, and a NiMo or CoMo catalyst, the hydrogen load ratio varying from 200N I of hydrogen/load liter to 1000 N I of hydrogen/load liter, obtaining a product with a boiling point in the diesel range with an improved cetane index, and a density less than that obtained by hydrotreatment of a pure hydrocarbon load.

Therefore, the invention provides a vegetable oil hydrotreatment process in which a proportion of 1 to 75% in mass of oils and/or natural fats, the rest being a mineral load, is hydrotreated under hydrotreatment conditions, in order to obtain diesel oil with an improved cetane index in relation to the hydrotreatment of mineral oil alone.

### BRIEF DESCRIPTION OF THE DRAWINGS

FIG. 1 attached, is a process schematic flowchart of the invention.

FIG. 2 attached, is a graph illustrating the IQT/DCN of heavy diesel (HD) by castor oil content and reaction temperature. Curve 1 represents the data at 360° C., while Curve 2 the data at 380° C.

FIG. 3 attached, is a graph that illustrates the IQT/DCN of the REPLAN load by the vegetable oil (VO) content and the reaction temperature. Curves 1 and 2 represent the data for the castor oil at 350° C. and 370° C. respectively, while Curves 3 and 4 are the data for soya oil, at the same temperatures of 350° C. and 370° C. respectively

FIG. 4 attached, is a graph that illustrates the IQT/DCN of light diesel (LD) by castor oil content and reaction temperature. Curve 1 represents the data for 340° C., while Curve 2 the data for 360° C.

FIG. 5 attached, is a graph that illustrates the plugging temperature of a diesel fuel system for a heavy diesel (HD) by castor oil content and reaction temperature. Curve 1 represents the data for 360° C., while Curve 2 the data for 380° C.

FIG. 6 attached, is a graph that illustrates the plugging temperature of a diesel fuel system for a REPLAN oil by vegetable oil content and reaction temperature. Curve 1 represents the data for 350° C. in the presence of castor oil and soya oil as well as soya oil at 370° C., while Curve 2 the data for castor oil at 370° C.

FIG. 7 attached, is a graph that illustrates the plugging temperature of a diesel fuel system for a light diesel (LD) by castor oil content and reaction temperature. Curve 1 represents the data for 340° C., while Curve 2 the data for 360° C.

FIG. 8 attached, is a graph that illustrates the density variation of the product obtained from pure heavy diesel and mixed with castor oil. Curve 1 represents the data for heavy diesel. Curve 2 the data for heavy diesel plus 10% in mass of castor oil and Curve 3 the data for heavy diesel plus 30% in mass of castor oil.

FIG. 9 attached, is a graph that illustrates the density variation of the product obtained from a pure REPLAN oil and mixed with different vegetable oils. Curve 1 represents the data for the pure REPLAN oil, Curve 2 the REPLAN oil plus 10% soya oil (SO), and Curve 3 the REPLAN oil plus 10% castor oil.

FIG. 10 attached, is a graph that illustrates the density variation of a product obtained from light diesel, by the content in mass of castor oil and reaction temperature. Curve 1 represents the data for 340° C. and Curve 2 the data for 360° C.

FIG. 11 attached, is a graph that illustrates the stability of products obtained from a REPLAN oil by the content in mass of vegetable oil for different oils and different temperatures. Curve 1 represents the data for castor oil at 350° C., Curve 2 castor oil at 370° C., Curve 3 soya oil at 350° C. and Curve 4 soya oil at 370° C.

### DETAILED DESCRIPTION OF THE PREFERRED MODEL

The coprocessing of vegetable oils mixed with mineral oil, in existing HDT units, is an alternative for incorporating a low added value flow to the refinery's diesel pool, not only for having a high cetane number but also for reducing the density, as normal paraffins have low density and the HDT process has limitations for attaining this specification with very aromatic loads (high LCO content).

Another important factor is the use of castor oil, which unlike other vegetable oils hydrocracks, producing C10 and C11 paraffins as well as C17 and C18 paraffins, therefore having lower density than other vegetable oils studied.

Another important factor is, that diluted with vegetable oil (VO) the industrial unit can operate at temperature ranges below 340° C., which is lower than the temperatures shown by process patents with pure VO.

Also highlighted is the improved plugging point for diesel oils used in Brazil, which is contrary to the results in existing patents, possibly because in countries with a colder climate, diesel oil is lighter than that used in tropical countries.

The hydrotreatment of vegetable oils in accordance with the invention includes, therefore, hydrotreatment under hydrotreatment conditions, of a mineral load with between 1 and 75% in mass of a vegetable oil or animal fat load.

The useful vegetable oils for the invention's process includes soya oil (Glycina max), castor oil (Ricinus communis), palm oil (Elaeis guineensis) and peanut oil (Arachis hypogaea). Among these, castor oil is the preferred.

The useful vegetable load for the process can be any vegetable or animal oil, without the need of purification, except for particulates, water and dissolved salts.

Castor oil is obtained from pressing the seeds produced by the plant Ricinus Communis, which is found in practically all tropical or subtropical countries, and can be propagated from seeds. The fundamental characteristic of the oil is its low variability, both in the quantity of oil from mature seeds and the composition of the obtained oil, the production of which varies between 45 and 49% per seed mass. Castor oil contains around 87 to 90% Ricinoleic Acid, 1% palmitic acid and 4.2% linoleic acid.

The most commonly used recovery process firstly presses the seeds followed by extraction with solvent and, when pressing is done at a high temperature, it is necessary to purify the oil by removing toxic proteins (ricin). The process efficiency is from 75 to 85%, 10 to 20% is retained in the pressed solid residue.

For purifying vegetable oil a centrifugal process is normally used for removing proteins in suspension (degumming process).

Soya oil is also the preferred vegetable load, principally aimed at recycling used oils from restaurants, for example.

The mineral loads used and their analysis is show in Table 1 below.

TABLE 1

| | | | | | | N | |
|---|---|---|---|---|---|---|---|
| | | | Viscosity. | | | ANTEK | S |
| | Dens. | R.I. | 20° C. | 37.8° C. | 50° C. | 7000 | R—X |
| Loads | 20/4° C. | 20° C. | cSt | cSt | cSt | ppm | ppm |
| HD | 0.9075 | 1.505 | 55.71 | 22.62 | 13.79 | 1599 | 6349 |
| REPLAN | 0.8925 | 1.4998 | 12.93 | 7.057 | 4.992 | 1642 | 6234 |
| LD | | 1.472 | | | | 96.4 | 2590 |
| CO | 0.9593 | 1.479 | 245.4 | 84.26 | 18.99 | 31.22 | 7.65 |

Where: R.I. = Refraction Index, ASTM D 1218 and ANTEK 7000 = Total Nitrogen Analysis, ASTM D 4629

The loads are selected in order to determine the crackability of the vegetable oil and to verify the synergic effects in relation to the other important process reactions, determining if any important diesel specification may not be obtained, due to the impact of the vegetable oil on the catalyst.

The useful mineral loads in the process are: heavy diesel (HD) which is the largest components of the refinery's pool; light diesel (LD), to verify the impact on the low temperature specifications and the REPLAN load. The REPLAN load is a mixture of a LCO flow and/or coking processes gasoil used in the REPLAN HDT unit and represents a typical load, at Petrobras, of a HDT unstables unit for city diesel production.

It is equally possible to combine vegetable oil and animal fat loads in any proportion.

The catalysts used in hydrotreatment (HDT) are basically metal oxides, totally or partially converted to γ-alumina (γ-Al₂O₃) supported sulfides (active phase). The conversion of the oxides to sulfides (sulfidation) is made in the hydrotreatment reactor itself. The active phase has the hydrogenolysis and hydrogenation processes. The support has the basic role of providing a specific high area, where the active components are found dispersed in the form of small particles. Additionally, the support provides mechanical resistance and thermal stability, impeding sintering (active phase agglomeration). The y-alumina has a specific area between 200 and 400 m²/g, pore volume of from 0.5 to 1.0 cm³/g and acidity classified as from weak to moderate. There is a synergic effect between the metal sulfides of groups VI-B (Mo and W) and VII (Co and Ni), to various reactions involved in the hydrotreatment process, so that the activity of the catalysts containing sulfides, of both groups, is much greater than the activity of the individual sulfides. Therefore, the mixed sulfides are normally used as the active phase (Co—Mo, Ni—Mo, Ni—W, Co—W), as the optimum relationship between the Group VIII metal and the Group VI-B metal is in the range 0.33 to 0.54.

In the diesel production hydrotreatment process, the reaction occurs in the presence of hydrogen at high pressure, in the operation range of 4 MPa to 10 MPa, preferably 5 MPa to 8 MPa. The average temperature of the catalytic bed can vary between 320° C. and 400° C., preferably between 340° C. and 380° C., with spatial velocity varying from 0.5 h⁻¹ to 2 h⁻¹, preferably 0.8 h⁻¹ to 1.2 h⁻¹. The catalytic bed may be divided into two or more stages with an injection of cold nitrogen between stages for temperature control, hydrogen load ratio varying from 200N I of hydrogen/load liter to 1000N I of hydrogen/load liter.

The hydrotreatment reaction experimental conditions are determined from the typical conditions of a HDT unstables unit, in this way the variables: pressure (9 MPa), LHSV (1 h⁻¹) and the H₂/load relationship (800 NI/load liter) are maintained constant. The temperatures are adjusted in accordance with the load's refractivity, that is loads with a higher boiling point, or LCO content, are tested at higher temperatures. The tests are planned in order that there is always, for the same experimental condition, a test with pure mineral oil (MO) without the addition of Vegetable oil (VO), to determine the difference in efficiency due to the presence of the vegetable oil studied.

The invention process will be described below, with a reference to the attached Figures.

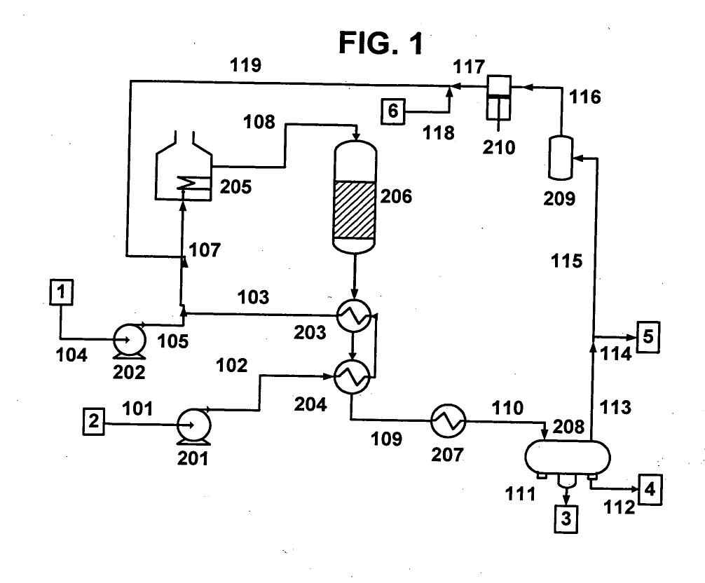

In FIG. 1, the mineral oil (2) is driven via line (101) to the pump (201), which raises the flow's operational pressure, after which the oil is sent by line (102) to the set of heat exchangers (204) and (203), which heat the oil recovering heat from the process products. The heated product is pressurized and sent by line (103). The vegetable oil (1) enters the unit via line (104) and is pumped by the pump (202), which pressurizes the flow (105) to the unit's pressure. Then flow (105) is mixed with flow (103), forming flow (106), which is in turn mixed with the hydrogen rich recycle gas flow (119), starting the flow (107). Flow (107) is sent to the furnace (205), where flow (107) is heated, forming flow (108), up to the reactor's (206) inlet temperature.

The reactions are exothermic and, therefore, there is an increase in temperature along the catalytic bed, therefore the outlet product is at a higher temperature than the inlet temperature, giving rise to flow (109) where part of the heat is recovered by the exchangers (204) and (203) which heats the mineral oil (2) load. The flow (109) is cooled again, this time with cooling water, to condense the light products formed, which are separated from the gas flow in vessel (208), where a flow (111) of produced water from the process is also separated, which is sent to the refinery's sour water system (3) for treatment.

The hydrocarbon flow (112), containing the product from VO hydrocracking, is sent to the rectifier tower (not represented), where the hydrogen sulfide gas and the ammonia, produced by the HDS and HDN reactions respectively, are removed. The propane is recovered and the specified diesel (4) is sent for storage. The gas flow (113) arising from (208), is rich in non-reacted hydrogen, but may also have a high hydrogen sulfide gas content, which may prejudice the reactions. Therefore the hydrogen sulfide gas content is maintained below a minimum range by a blow down (5) flow (114). The blow down flow (115) passes vessel (209) for retaining any liquid compound that may have been carried, giving rise to flow (116) which is compressed by the compressor (210) up to the furnace (205) inlet pressure, starting flow (117). Flow (117) is mixed with flow (118), which contains pure hydrogen to compensate for the hydrogen consumed. The hydrogen rich flow (1 19) is then mixed with flow (106) at the furnace (205).

Proof of the technical viability of the proposed process will described below, based on the evaluation of the parameters, such as IQT/DCN (equivalent to the cetane number), density of the products obtained from coprocessing and temperature of the plugging point of a diesel engine, running with hydrotreated oil obtained from the invention's process.

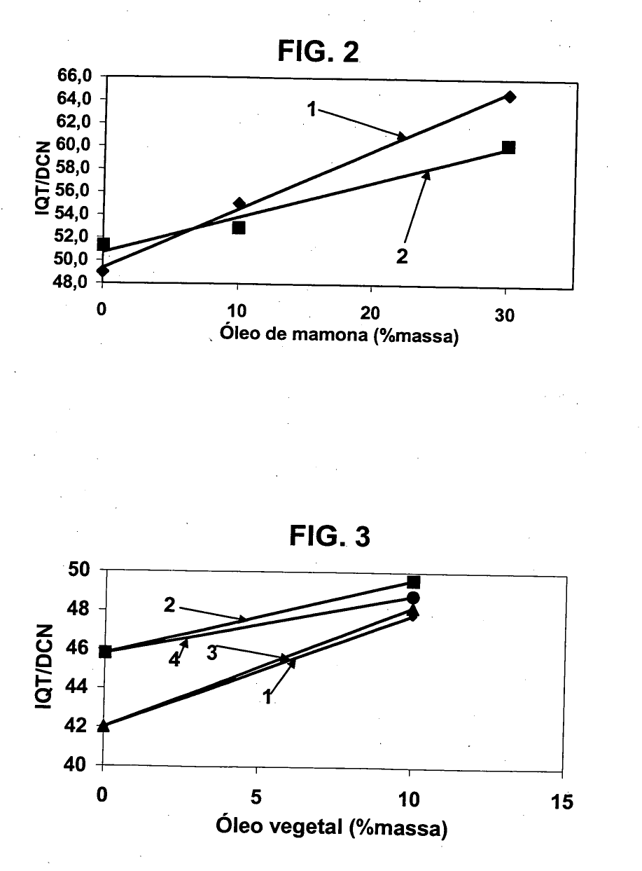

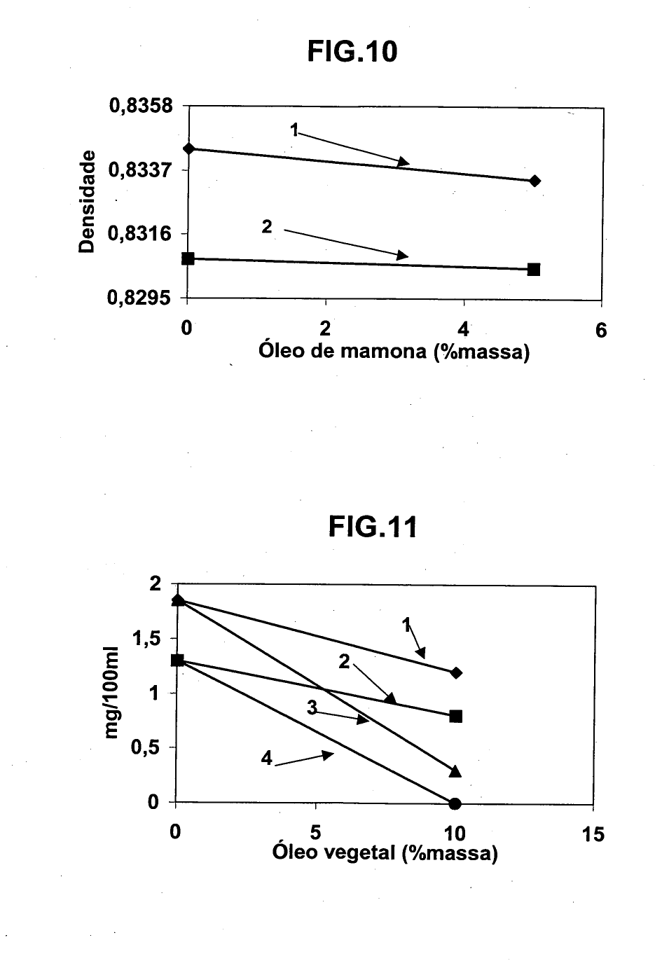

Evaluation of the parameters is illustrated by reference to FIGS. 2 to 11.

IQT/DCN

Diesel quality is associated to its auto-ignition capability, for this purpose a device called an IQT/DCN (Ignition Quality Tester) was used, which allows the ignition quality of a fuel to be determined in accordance with ASTM D 6890-03 and IP 498/03. The results are shown in the form of the DCN (Derived Cetane Number) which is the equivalent of the CN (Cetane Number) obtained in a diesel cycle engine, as per ASTM D613.

This parameter shows that the hydrotreatment of vegetable and mineral loads brings a sharp improvement of the diesel oil's specification, as was expected by the concept of the invention, as the liquid product from the VO hydrotreatment would be basically linear hydrocarbons and, therefore, with a high IQT/DCN, so the greater the quantity of VO the higher the product's IQT/DCN, as shown in FIGS. 2 and 3. The effect of temperature, relatively reducing the IQT/DCN, can be explained by the cracking of higher paraffins into lower paraffins, which have lower IQT/DCN.

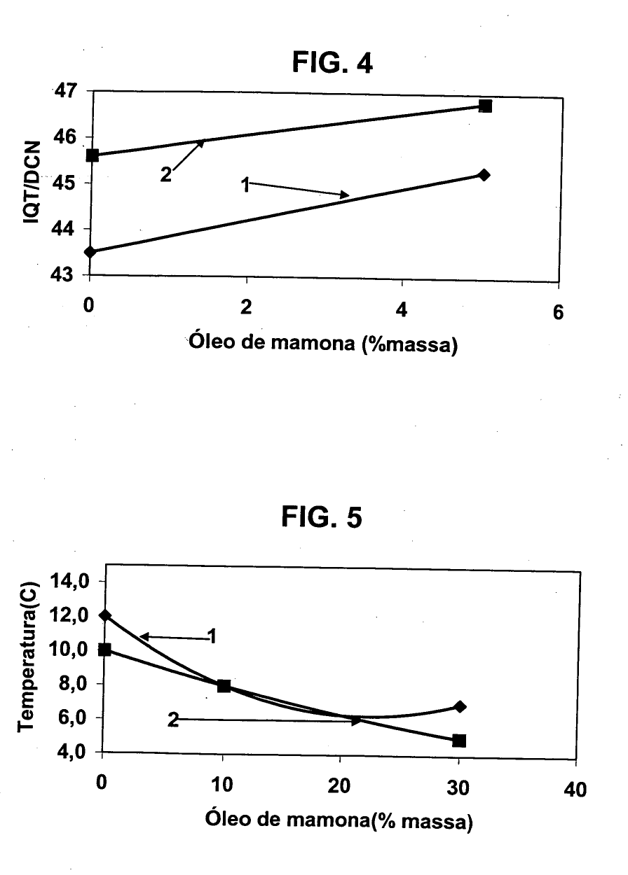

Another relevant fact is that in accordance with FIG. 4, low content with 5% results in improved sensitivity of this specification. Therefore, the processing of small quantities of VO in existing HDT unstables units requires little investment, whereas the processing of larger quantities requires a more detailed study of the unit's characteristics such as excess hydrogen, recycle compressor maximum flow rate, etc.

Diesel Engine Plugging Point

One of the problems that can be caused by normal paraffins arises from their high melting point, which can lead to plugging of the engine's fuel system. Analysis of the plugging point reflects the quantity of filtered particulate formed with the lowering of the temperature, therefore the lower the plugging point is, the lower the ambient temperature is in which the vehicle can operate, making this specification extremely important, mainly if the fuel is used in geographical areas with cold climates.

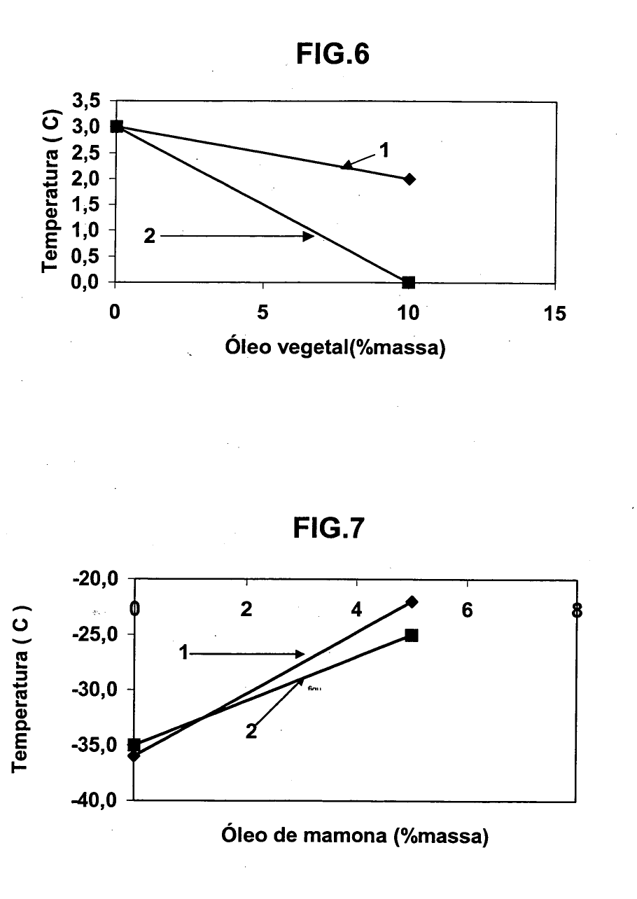

In the cases of heavy diesel (HD) and from the REPLAN load, FIGS. 5 and 6 respectively, as they are heavy fuels and appropriate for a country with a tropical climate, the base load has a high plugging point, and the generated paraffins may even improve the plugging point of the final product, due to the dilution effect. However, for a lighter load, similar to that used in countries with a cold climate, the effect is prejudicial, as shown by the graph in FIG. 7.

Effect on Product Density

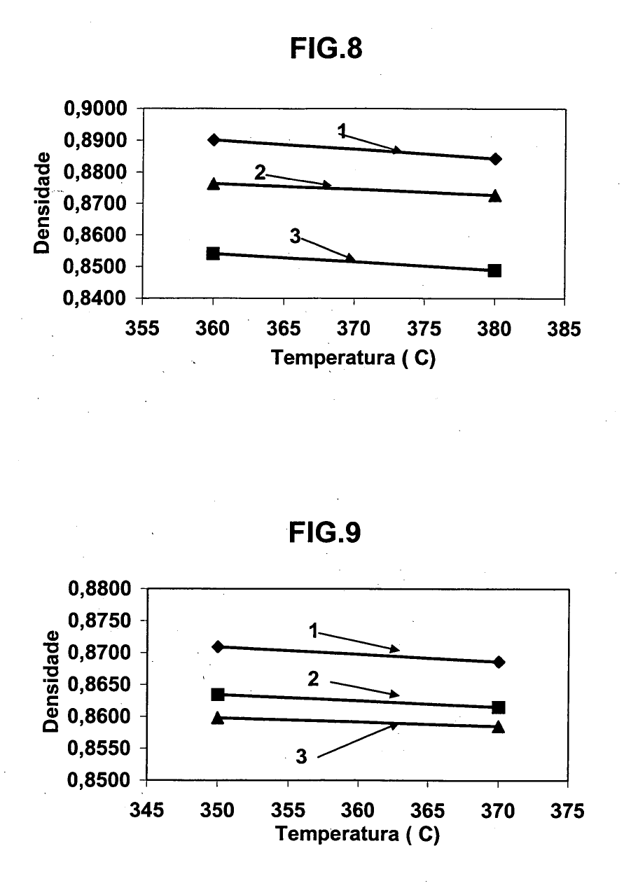

Analysis of product density reveals a very sharp decrease in density, indicating that the vegetable oil (VO) cracks producing lighter hydrocarbons than the product from hydrogenated castor oil (CO). An equivalent reduction can be seen for all loads, therefore, as shown by FIGS. 8, 9 and 10, there is no interference to the quality of CO with the crackability of VO.

LPR Analysis

One of the big problems of using vegetable oils, even vegetable oil esters, as a fuel, is the low oxidation stability due to the presence of olefins. The HDT process not only eliminates the oxygen heteroatoms but also hydrogenates all in saturations, therefore the specification that measures stability of fuel to oxidation, LPR, is improved when compared with the base oil, with a lower insolubles content, as shown by the graph of FIG. 11.

Volumetric Efficiency

The volumetric efficiency shown by vegetable oil HDT, has an important production of propane (main component of domestic gas) and the production of one liter of diesel oil for each liter of VO processed. This fact is a consequence of the lower product density relative to the density of VO, therefore there is an increase in volumetric efficiency. Table 2 below, shows the volumetric efficiency for castor and soya oil.

TABLE 2

| Load | Water | Methane | Propane | Diesel |
|---|---|---|---|---|
| One Liter | Liter | Normal Liter | Normal Liter | Liter |
| Castor Oil | 0.14 | 18 | 20 | 1 |
| Soya Oil | 0.09 | 15 | 20 | 1 |

-Product quality of other processed oils

Based on the kinetic mechanism developed from the experimental data obtained, it is possible to calculate the quality of the products obtained from processing vegetable oils other than castor and soya oil. As can be seen in Table 3 below, where the IQT/DCN values and density of the obtained products is listed. There are important differences in both the density and IQT/DCN value, indicating that the best oil to be processed depends not only on its availability and market value, but also on the refinery's objectives in particular, i.e. if the specification limitation is in the IQT/DCN or the density.

TABLE 3

| Analyses | Peanut oil | Babassu Oil | Palm Oil | Soya Oil | Castor Oil |
|---|---|---|---|---|---|
| IQT | 103 | 92 | 101 | 102 | 94 |
| Density | 0.7800 | 0.7644 | 0.7779 | 0.7803 | 0.7619 |

The description in this report, as well as the accompanying Figures and Tables, prove the excellence of the invention, in the sense that it presents a process where the addition of a proportion of an oil or a natural fat, to an oil hydrocarbon load in a hydrotreatment process, produces a diesel oil with various improved characteristics, as well as an environmental interest when soya oil is used. Additionally, it is possible to adjust the vegetable oil used to the refinery's objectives, in terms of the IQT and density of the product obtained.

1. Process for the hydroconversion of vegetable oils, in the presence of a hydrogen flow, hydroconversion catalysts and hydroconversion conditions, to obtain diesel oil, the said process is characterized by the following:
a) Provide an oil or natural fats;
b) Provide a hydrocarbon oil;
c) In a hydroconversion reactor and in the presence of a catalyst and hydrogen flow, pressure and temperature, effect the hydroconversion;
d) Recover a diesel oil flow, in which:
i) The IQT of the diesel oil obtained is higher than for diesel oil obtained by the hydroconversion process of pure hydrocarbons;
ii) The density of the diesel oil obtained is lower than for diesel oil obtained by the hydroconversion process of pure hydrocarbons;
iii) The oxidation stability of the diesel product, as measured by LPR, is higher than for diesel oil obtained by the hydroconversion of pure hydrocarbons.

2. Process in accordance with claim 1, characterized by the following stages:
a) The mineral oil (2) is pressurized in (201) and heated by thermal exchange in (204) and (203) and sent by the same line (103);
b) The oil or natural fat (1) is pressurized in (202), obtaining flow (105);
c) Mix the mineral oil flow (103) with the oil or natural fat flow (105), obtaining flow (106), which is then mixed with the hydrogen rich recycle gas flow (119), from which originates flow (107);
d) Heat flow (107) in furnace (205), forming flow (108), up to the inlet temperature of reactor (206), where hydroconversion reactions occur, in the presence of a sulfide catalyst of Group VI and Group VIII, 4 MPa to 10 MPa pressure, catalytic bed average temperature from 320° C. to 400° C., spatial velocity from 0.5 h⁻¹ to 2 h⁻¹, hydrogen load ratio varying from 200N I of hydrogen/load I to 1000N I of hydrogen/load I, with exothermic reactions which raises the temperature along the catalytic bed;
e) Separate the product from the reactor (206) outlet at a temperature higher than the inlet temperature, flow (109), which is cooled for the condensation of the formed light products, which are separated from the gas flow (113) in vessel (208), where a flow (111) of water produced by the process is also separated, which is sent to the refinery's sour water system (3) for treatment;
f) Separate the hydrocarbon flow (112), containing the product from the VO hydrocracking, and send it for rectification;
g) Recover the specified diesel (4).

3. Process in accordance with claim 1, characterized by the use of vegetable oil, which may be castor, soya, rape seed, peanut, palm and babassu oils, pure or mixed in any proportions.

4. Process in accordance with claim 3, characterized by the use of castor oil.

5. Process in accordance with claim 3, characterized by the use of used soya oil.

6. Process in accordance with claim 3, characterized by the use of any animal fat.

7. Process in accordance with claim 3, characterized by the use of a natural load, which is a mixture of vegetable oil and animal fat in any proportion.

8. Process in accordance with claim 1, characterized by the use of vegetable oil or animal fat used in a proportion between 1 and 75% in mass in relation to the petroleum oil.

9. Process in accordance with claim 1, characterized by the use of mineral oil, which is heavy diesel, light diesel or a mixture of flows such as LCO and/or coking process gasoil.

10. Process in accordance with claim 1, characterized by the substitution of glycerine production, typical of transesterification processes, for propane production, incorporated in the liquefied gas flow.

11. Process in accordance with claim 1, characterized by the production of a liter of diesel oil for each liter of vegetable oil processed.

12. Process in accordance with claim 1, characterized by the vegetable oil to be hydrotreated, being chosen in accordance with the desired IQT/DCN value or density of the final product.
